(19) United States
(12) Patent Application Publication
(10) Pub. No.: US 2007/0241934 A1
(43) Pub. Date: Oct. 18, 2007

(54) Pedestrian signal and method for the manufacture thereof

(76) Inventors: Mark R. Leatt, Bradenton, FL (US); Peter W. Ragsdale, Carlsbad, CA (US)

Correspondence Address: BRINKS HOFER GILSON & LIONE, P.O. BOX 10395, CHICAGO, IL, 60610, US

(21) Appl. No.: 11/729,317

(22) Filed: Mar. 28, 2007

Related U.S. Application Data
(60) Provisional application No. 60/788,769, filed on Apr. 3, 2006.

(51) Int. Cl. G08G 1/095

(52) U.S. Cl. 340/944

(57) ABSTRACT

A method of making an insert for a pedestrian signal includes providing a mold having at least one cavity defining an outline of a person, injecting a plastic material into the at least one cavity of the mold at high pressure and thereby filling the at least one cavity, and cooling the plastic material and thereby forming a pedestrian insert, and removing the pedestrian insert from the mold. The insert includes a plurality of thin wall sections defining a plurality of light tunnels. The plurality of light tunnels includes at least a first light tunnel defining a head portion and an upper leading arm portion. In one embodiment, the plurality of light tunnels further includes at least a second light tunnel defining a trailing arm portion and a third light tunnel defining at least in part an upper portion of the trailing arm portion, wherein the third light tunnel extends approximately midway along a length of the second light tunnel. A pedestrian signal incorporating an insert is also provided.

This application claims the benefit of U.S. Provisional Application No. 60/788,769, filed Apr. 3, 2006, the entire disclosure of which is hereby incorporated herein by reference.

### FIELD OF THE INVENTION

The present invention relates generally to a pedestrian signal, and in particular, to a pedestrian signal having an insert that provides a uniformly illuminated surface and also to the method of manufacturing the insert and signal.

### BACKGROUND

It is known to use pedestrian signals to provide advisory indicia to pedestrians about impending signal light changes and whether there is adequate time to safely cross a roadway. For example, some pedestrian signals switch from a lighted pedestrian signal outlining a person, which indicates that it is safe to proceed across a roadway, to a lighted hand signal, which indicates that a signal change is impending. In some cases, the hand signal will initially flash and then remain lit when the signal change is imminent. Some signals use an additional “countdown” symbol to advise the pedestrian about the amount of time remaining until the signal change.

In some instances, the signal includes an insert and a lens. The insert forms light tunnels that in turn define the person and portions of the hand. Accordingly, a light or lights can be activated such that they are visible through select light tunnels and the lens to define only the person. Alternatively, another light or lights can be activated through select light tunnels and the lens to define the hand. Select light tunnels are also used for the countdown number symbols. For example, U.S. Traffic Corp. offers a Model LEDP-HMC-001 LED pedestrian hand/man module with LED countdown using inserts that define light tunnels.

Because the insert must direct light for both the person and hand, the insert has a relatively complex shape, formed from thin walls having a relatively large height to define the light tunnel. In one prior art embodiment, the insert was formed by inserting a core into a mold to displace a resin material, which was then allowed to expand as it cured. The curing process, however, can take a relatively large amount of time, for example on the order of 10 minutes.

### SUMMARY

Briefly stated, in one aspect the invention is directed to a method for manufacturing a pedestrian signal insert. The method includes providing a mold having at least one cavity defining an outline of a person. The method further includes injecting a plastic material into the at least one cavity of the mold at high pressure and thereby filling the at least one cavity. The method further includes cooling the plastic material and thereby forming a pedestrian insert, and removing the pedestrian insert from the mold.

In one embodiment, the plastic material is injected into the mold at greater than 8000 psi. In one desired embodiment, the plastic material is injected into the mold at about 10,000 psi. In one embodiment, the plastic material is injected into the mold in less than about 20 seconds, and the material is cooled in less than about 30 seconds.

These various embodiments provide a simple, robust and inexpensive solutions for manufacturing the insert. In addition, the time for making the insert is reduced by an order of magnitude, thereby allowing the manufacturer to more quickly produce the inserts.

In another aspect, the insert includes a plurality of thin wall sections defining a plurality of light tunnels. The plurality of light tunnels includes at least a first light tunnel defining a head portion and an upper leading arm portion. In one embodiment, the plurality of light tunnels further includes at least a second light tunnel defining a trailing arm portion and a third light tunnel defining at least in part an upper portion of the trailing arm portion. The third light tunnel extends approximately midway along a length of the second light tunnel. In one embodiment, the upper portion of the trailing arm portion defined by the third light tunnel includes an upper region and a lower region, wherein the lower region has a greater width than the upper region.

In yet another aspect, a pedestrian signal includes an insert, a lens overlying the insert on one side thereof, and a light source positioned on a side of the insert opposite the lens.

The various configurations of the insert and signal provide significant advantages. For example, due to the configuration of the light tunnels, and the larger spacing provided thereby, the pedestrian is provided with better and more uniform visibility of the signal indicia. In addition, the improved manufacturing process is extremely fast and efficient, thereby reducing costs.

The foregoing paragraphs have been provided by way of general introduction, and are not intended to limit the scope of the following claims. The various preferred embodiments, together with further advantages, will be best understood by reference to the following detailed description taken in conjunction with the accompanying drawings.

### BRIEF DESCRIPTION OF THE DRAWINGS

FIG. 1 is a perspective view of a pedestrian signal.

FIG. 2 is a perspective view of the pedestrian signal with the lens removed.

FIG. 3 is a plan view of a pedestrian signal insert.

FIG. 4 is a perspective view of the insert shown in FIG. 3.

FIG. 5 is a plan view of a countdown signal insert.

FIG. 6 is a perspective view of the insert shown in FIG. 5.

FIG. 7 is a view of a pedestrian signal insert superimposed on a lens.

FIGS. 8A and 8B are a plan view of two mold halves for the pedestrian insert.

FIG. 9A and 9B are a plan view of two mold halves for the countdown signal insert.

### DETAILED DESCRIPTION OF THE PRESENTLY PREFERRED EMBODIMENTS

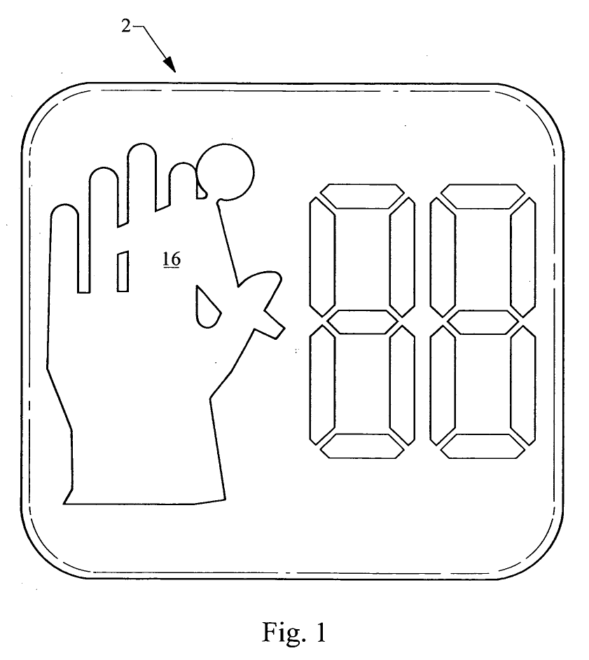

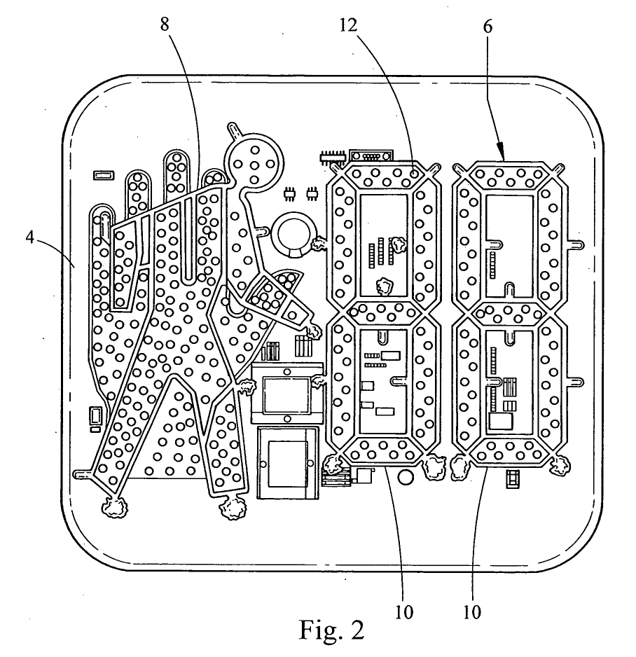

Referring to the drawings, and in particular FIGS. 1 and 2, a pedestrian signal 2 includes a housing 4 forming a cavity 6, a pedestrian signal (hand/man) insert 8 and a pair of countdown signal inserts 10 positioned side-by-side. The pedestrian signal insert 8 is positioned in the cavity 6 on a left hand side of the housing, while the countdown signal inserts 10 are positioned in the cavity on a right-hand side, although it should be understood that the position of the inserts could be reversed, or positioned one over the other top-to-bottom.

A plurality of LED lights 12 are arranged in an array at the back/bottom of the housing cavity so as to underlie the pedestrian signal insert 8 and the countdown signal inserts 10. Other LED lights 14 are positioned outside of the inserts and underlie portions of a lens 16 defining portions of a hand signal 18, outlined on the lens (see FIG. 7). The LED's are interconnected to minimize any effect of LED failure. The LED's have a longer life than incandescent or neon lights and require less energy than conventional light sources. One suitable LED is a white light available as Nichia NSPW500BS. A suitable orange LED light is the Toshiba TLOE17TP light. In one embodiment, 54 white lights are situated to underlie the portion of the pedestrian signal insert defining the man indicia. In one embodiment, approximately 160 orange lights are used for the hand indicia, while 54 lights are used with each of the countdown signal inserts.

The signal includes countdown logic providing for different display sequences of the pedestrian signal and the countdown signal. For example, the counter display can be programmed to provide various user selectable modes as shown in Table 1 as follows:

TABLE 1
DISPLAY MODES

| USER | | | | |
|---|---|---|---|---|
| SELECTABLE | | | | |
| MODE | FACTORY | | COUNTER | FLASHING |
| (LEDP- | PRESET | DON'T | DISPLAY | DON'T |
| HMC-002) | MODE | WALK | WALK | WALK |
| 0 | n/a | Blank | Blank | Blank |
| 1 | LEDP- | Blank | Countdown | |
| | HMC-002A | | | |
| 2 | LEDP- | Blank | Countdown | Countdown |
| | HMC-002B | | | |
| 3 | LEDP- | Blank | Blank | Countdown |
| | HMC-002C | | | |
| 4 | LEDP- | Blank | Countdown | Blank |
| | HMC-002D | | | |
| 5 | Available | Blank | Countdown with | |
| | on request | | flashing display during | |
| | | | Pedestrian Clearance | |
| 6 | Available | Blank | Countdown | Flashing |
| | on request | | | Countdown |
| 7 | Available | Blank | Blank | Flashing |
| | on request | | | Countdown |
| LEPD- | n/a | Blank | Blank | Countdown |
| HMC-001LA | | | | |

Referring to FIGS. 1-4, the pedestrian signal insert 8 has a plurality of thin wall sections 20 that define a plurality of light tunnels. In particular, the insert includes a light tunnel 26 defining a head portion and an upper leading left arm portion, a light tunnel 28 that defines an intermediate left arm portion, a light tunnel 30 that defines a lower left arm portion, a light tunnel 32 that defines a lower left leg portion, a light tunnel 34 that defines a torso and right leg portion, a light tunnel 36 that forms an upper portion of the torso, a light tunnel 38 that defines a trailing, right arm portion and a light tunnel 40 that defines at least in part an upper portion of the trailing right arm portion. The light tunnel 40 extends approximately midway along a length of the trailing arm portion light tunnel 38. The light tunnel 40 includes an upper region 42 and a lower region 44. The lower region 44 has a greater width than the upper region 42.

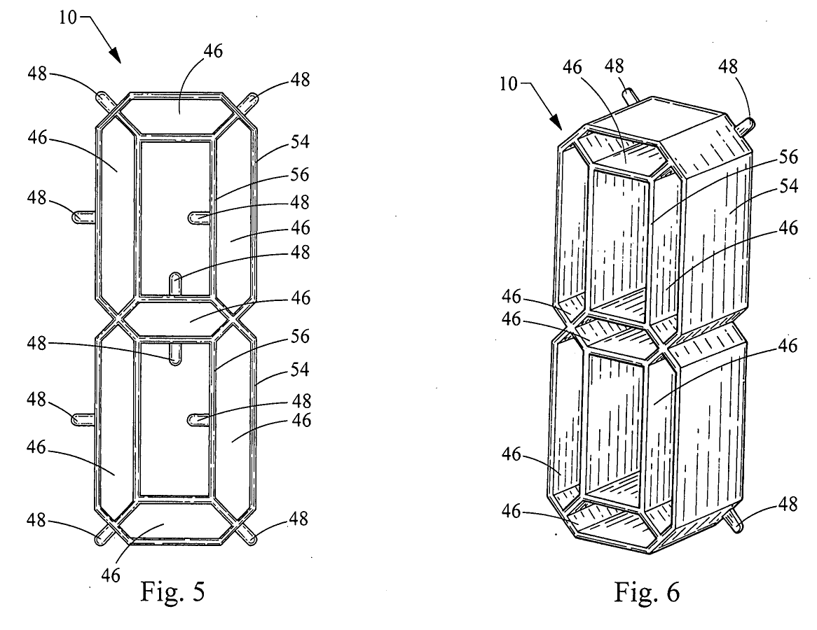

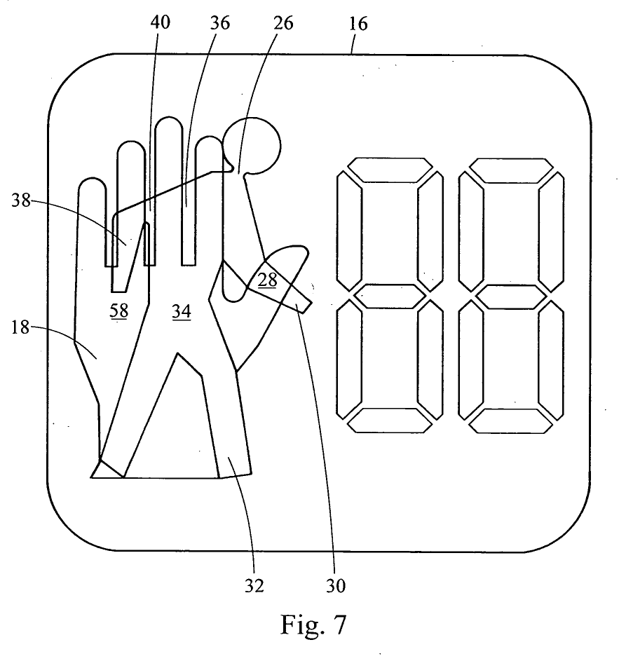

Referring to FIGS. 5 and 6, the countdown inserts each have inner and outer walls 54, 56 that define seven light tunnels 46, which can be selectively illuminated to form digits 0-9.

In one embodiment, the inserts 8, 10 are each integrally formed from an ABS material, preferably with a UV stabilizer. In one embodiment, the material is a Tailtalac ABS 6000 black available from Balcof Plastics.

The inserts 8, 10 further includes a plurality of tab portions 48 extending substantially perpendicular from select ones of the plurality of thin walls 20. The tab portions 48 are bonded, for example with an adhesive, to the lens 16. In one embodiment, the tabs are about 0.125 inches thick. At least some of the plurality of thin walls 20 have a thickness of between about 0.090 inches and about 0.150 inches. For example, in one embodiment, the walls 54, 56 of the countdown insert and the outer periphery walls 22 of the hand/man insert have a thickness of about 0.125±1.005 inches minus the mold draft, with a 0.25 degree draft angle. Some of the inner or interior walls 24 of the hand/man insert 8 have a thickness of about 0.100±1.005 inches minus the mold draft. The thin walls 22, 24, 54, 56 have a height of between about 2.5 inches and about 2.75 inches, and in one embodiment a height of about 2.600±0.015 inches.

In operation, selected ones of the LED lights 12 are arranged in various zones associated with various light tunnels of the inserts 8, 10. For example, with the hand/man insert 8, some zones require white light only (man only), some require orange light only (hand only), and others require both white and orange light. The lens 16 includes an outline of a hand shape 18 that overlies certain selected light tunnels.

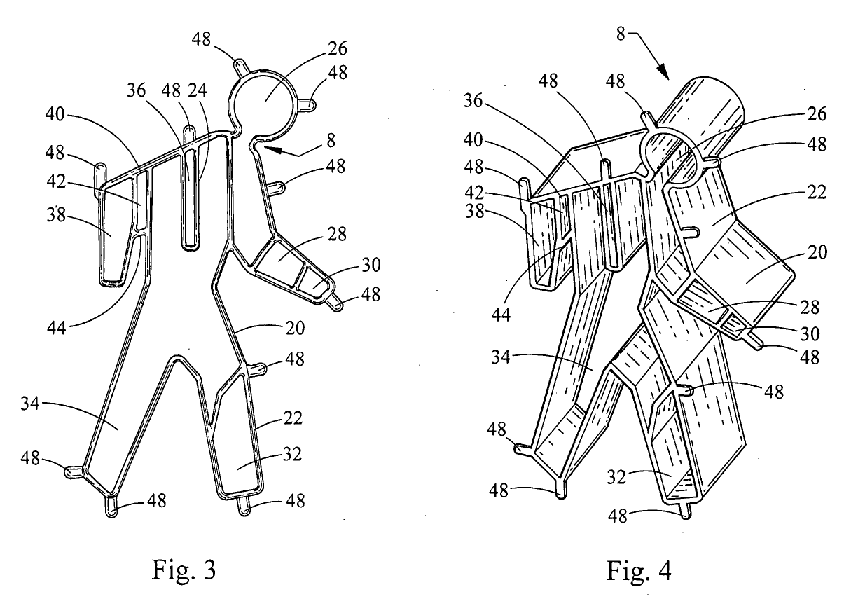

Referring to FIGS. 3, 4 and 7, the lights underlying the light tunnels 26, 30, 32, 36, and 40 are white light only, since they are not aligned with or underlie the hand shape of the lens. Conversely, the lights underlying the light tunnels 28, 34, and 38 are orange and white, since then define both the hand indicia and the man indicia. The lights switch from white, when illuminating the man indicia, to orange when illuminating the hand indicia. Finally, the lights 58 underlying the hand outside of the insert are orange only, since they do not define the man indicia. The lights underlying the countdown inserts 10 can be white, orange, a combination thereof or any other color or combination deemed appropriate by the user. The construction of the light tunnels, with their relatively large height, minimizes any pixel effect of the LED lights, which are displaced a relatively large distance from the lens, and maintains a uniformly illuminated surface as the light is diffused.

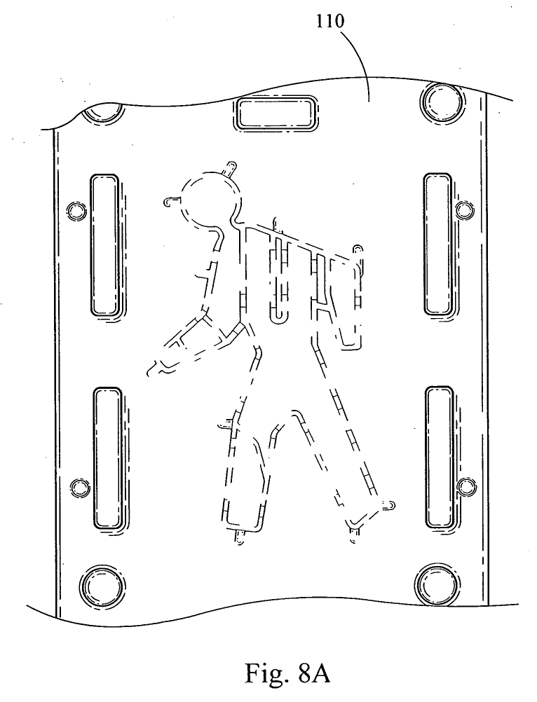

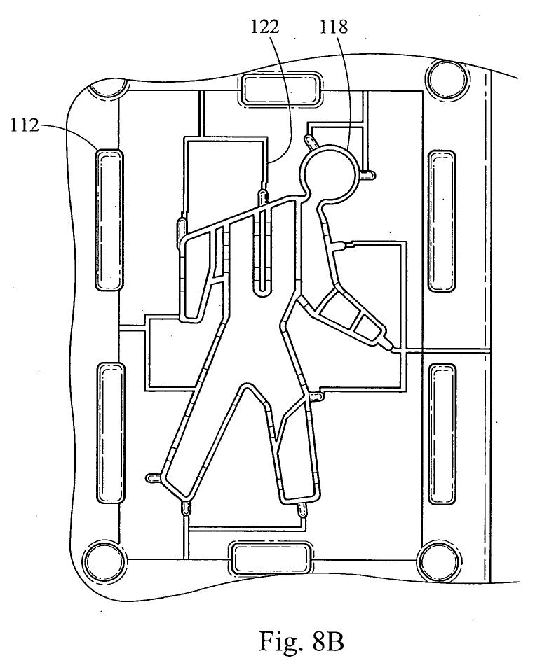

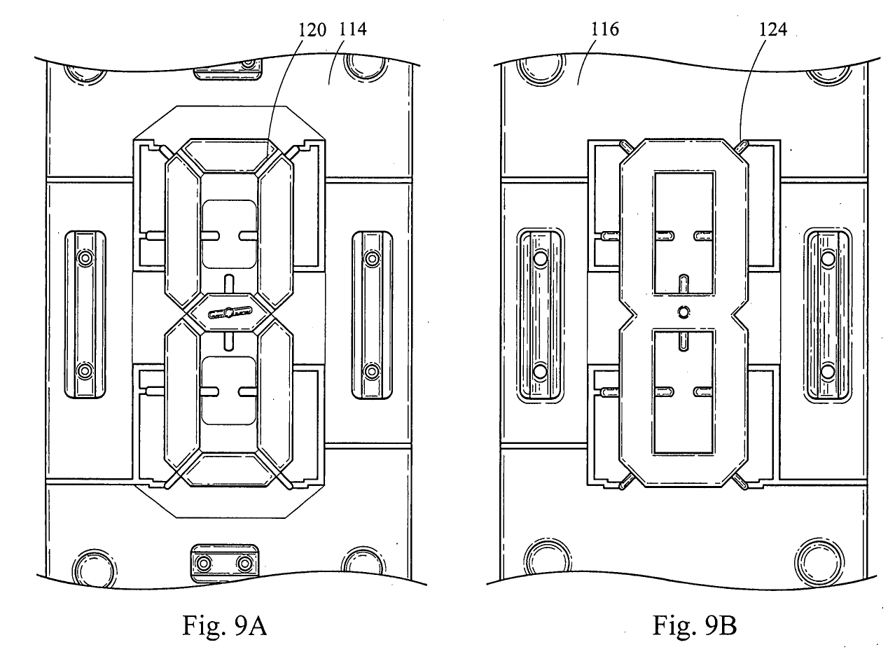

Referring to FIGS. 3-6, 8A-B, and 9A-B, the inserts 8, 10 are manufactured by maintaining a mold (two halves 110, 112, 114, 116) at approximately 100° F. and injecting a molten plastic material (approximately 450° F.) into a mold cavity 118, 120 at one or more mold gates 122, 124 (e.g., three) at high pressure, for example at greater than 8,000 psi, and in one embodiment at approximately 10,000 psi. In one embodiment, the cavity is formed by the first and second mold halves (110, 112, 114, 116) being clamped together. The material fills the mold cavity or cavities in short amount of time, for example less than about 20 seconds and in one embodiment about 10 seconds. The mold and material are then cooled, or allowed to cool, so that the material solidifies. The cooling step takes less than about 30 seconds, and in one embodiment about 20 seconds. The mold is then opened and the insert removed, which takes less than 20 seconds, and in one embodiment approximately 10 seconds. The molded insert 8, 10 is then trimmed to complete the part.

Although the present invention has been described with reference to preferred embodiments, those skilled in the art will recognize that changes may be made in form and detail without departing from the spirit and scope of the invention. As such, it is intended that the foregoing detailed description be regarded as illustrative rather than limiting and that it is the appended claims, including all equivalents thereof, which are intended to define the scope of the invention.

What is claimed is:

1. A pedestrian signal insert for use in a pedestrian signal, the insert comprising:
a plurality of thin wall sections defining a plurality of light tunnels, wherein said plurality of light tunnels comprises at least a first light tunnel defining a head portion and an upper leading arm portion.

2. The pedestrian signal insert of claim 1 wherein said plurality of light tunnels further comprises at least a second light tunnel defining a trailing arm portion and a third light tunnel defining at least in part an upper portion of said trailing arm portion, wherein said third light tunnel extends approximately midway along a length of said second light tunnel.

3. The pedestrian signal insert of claim 2 wherein said upper portion of said trailing arm portion defined by said third light tunnel comprises an upper region and a lower region, wherein said lower region is wider than said upper region.

4. The pedestrian signal insert of claim 1 wherein said plurality of thin wall sections are integrally formed from an ABS material.

5. The pedestrian signal insert of claim 1 further comprising a plurality of tab portions extending substantially perpendicular from select ones of said plurality of said thin walls.

6. The pedestrian signal insert of claim 1 wherein at least some of said plurality of thin walls have a thickness of between about 0.090 inches and about 0.150 inches.

7. The pedestrian signal insert of claim 6 wherein said plurality of thin walls comprises at least a first set of thin walls having a first thickness, and at least a second set of thin walls having a second thickness, wherein said second thickness is different than said first thickness.

8. The pedestrian signal insert of claim 7 wherein said second set of thin walls define at least a portion of an outermost perimeter of the insert, and wherein said first set of thin walls are disposed interiorly of said outermost perimeter.

9. The pedestrian signal insert of claim 6 wherein said thin walls have a height of between about 2.5 inches and about 2.75 inches.

10. A pedestrian signal comprising:
an insert comprising a plurality of thin wall sections defining a plurality of light tunnels, wherein said plurality of light tunnels comprises a first set of light tunnels defining portions of a person and a hand and a second set of light tunnels defining portions of only said person, wherein said second set of light tunnels comprises at least a first light tunnel defining a head portion and an upper leading arm portion of said person;
a lens having an opening defining a combined outer peripheral shape of said hand and person, said lens overlying said insert on one side thereof; and
a light source positioned on a side of said insert opposite said lens.

11. The pedestrian signal of claim 10 wherein said first set of light tunnels comprises at least a second light tunnel defining a trailing arm portion, wherein said second set of light tunnels comprises a third light tunnel defining at least in part an upper portion of said trailing arm portion, and wherein said third light tunnel extends approximately midway along a length of said second light tunnel.

12. The pedestrian signal of claim 11 wherein said upper portion of said trailing arm portion defined by said third light tunnel comprises an upper region and a lower region, wherein said lower region is wider than said upper region.

13. The pedestrian signal of claim 10 wherein said plurality of thin wall sections are integrally formed from an ABS material.

14. The pedestrian signal of claim 10 wherein at least some of said plurality of thin walls have a thickness of between about 0.090 inches and about 0.150 inches.

15. The pedestrian signal of claim 14 wherein said plurality of thin walls comprises at least a first set of thin walls having a first thickness, and at least a second set of thin walls having a second thickness, wherein said second thickness is different than said first thickness.

16. The pedestrian signal of claim 15 wherein said second set of thin walls define at least a portion of an outermost perimeter of the insert, and wherein said first set of thin walls are disposed interiorly of said outermost perimeter.

17. A method for manufacturing a pedestrian signal insert comprising:
providing a mold having at least one cavity defining an outline of a person;
injecting a plastic material into said at least one cavity of said mold at high pressure and thereby filling said at least one cavity;
cooling said plastic material and thereby forming a pedestrian insert; and
removing said pedestrian insert from said mold.

18. The method of claim 17 wherein said forming said pedestrian insert comprising forming a plurality of thin wall sections defining a plurality of light tunnels, wherein said plurality of light tunnels comprises at least a first light tunnel defining a head portion and an upper leading arm portion.

19. The method of claim 17 wherein said injecting said plastic material into said at least one cavity of said mold at high pressure comprises injecting said plastic material into said mold at greater than 8000 psi.

20. The method of claim 17 wherein said injecting is completed in less than about 20 seconds and wherein said cooling is completed in less than about 30 seconds.

21. The method of claim 17 wherein said plastic material comprises ABS.
